(19) United States
(12) Patent Application Publication
(10) Pub. No.: US 2022/0112745 A1
(43) Pub. Date: Apr. 14, 2022

(54) Privacy Lock And Flush Pull With Integrated Strike Lockset

(71) Applicant: EMTEK Products, Inc., City of Industry, CA (US)

(72) Inventors: Jeffrey James Stephenson, Arcadia, CA (US); William Carl Zhang, Los Angeles, CA (US)

(73) Assignee: EMTEK Products, Inc., City of Industry, CA (US)

(21) Appl. No.: 17/070,828

(22) Filed: Oct. 14, 2020

(51) Int. Cl. E05B 65/08; E05B 15/02; E05C 3/06; E05B 35/00

(52) U.S. Cl. CPC E05B 65/0811; E05B 15/0205; E05Y 2900/132; E05B 35/008; E05C 3/06

(57) ABSTRACT

A sliding privacy door and lockset system for doors of the types generally known as “barn doors” and/or “pocket doors”, due to these doors being slidably mounted on a rail or rails positioned above a doorway or otherwise in or near a doorway. The present invention includes a lockset comprising a strike plate mounted to a door, and a lockset sub-assembly mounted to a door jamb. The lockset sub-assembly includes an actuating arm connected axially to a rotatable extension of a thumb turn. During operation, the distal end of the actuating arm rotates from an unlocked position to a locked position, that is, the distal end of the actuating arm rests within a slot in the strike plate. The strike plate may include a bump to limit the actuating arm's rotation, and a flush pull handle comprising an opening configured to provide a user's hand(s) with a place to grip.

### FIELD OF INVENTION

The invention relates to privacy locksets used for sliding doors of the type generally known as barn doors.

### BACKGROUND

Recently a style or type of sliding door known as a “barn door” has become popular for residential use. Typically, a conventional, residential barn door is mounted on a rail positioned above a door opening or doorway and is adapted to move back and forth along a rail mounted above the doorway, that is, reciprocate between a closed position and an open position. Due to increased residential use of this type of door, a need and an opportunity have arisen for multiple modifications and accessories that complement the functioning of this type of door when used in a residence or in another structure that is not a conventional barn. One such accessory is a conventional mechanism, known as a lockset that functions to lock the door in place in order to maintain privacy within the room or in some other space or area that is accessed through the doorway. Several simple, conventional locksets that provide a door locking function are known, including for example, a surface bolt and a jamb bolt. However, these simple, conventional locksets are problematic for several reasons. For example, they are very raw in appearance, and do not compliment or cooperate with a handle or “pull” used to open and close the door. Conventional handle, handle pull, latch bolt, and latch bolt strike components of these conventional locksets are problematic for several additional reasons. For example, when taken or viewed together, these components present a crowded, cluttered and confusing appearance. As a result, the user can be confused about the purpose of and/or location of one or more of the individual components. Also, determining an ideal or the best location for each component of a barn door residential lockset is problematic because each component competes for the prime location, that is, towards or near the leading edge of the door, and at arm's length from the user when the user is standing next to the door.

### SUMMARY OF INVENTION

The privacy lock and flush pull with integrated strike plate lockset (“residential barn door lockset” or “barn door lockset” or “lockset”), according to the present disclosure, overcomes the drawbacks of known barn door locksets that have, for example, raw or negative appearances, complexity of installation, and/or cluttered and/or confusing interfaces by providing a barn door lockset that is easy to install, has an elegant and designer appearance, functions in a simple and clear manner, and includes a combined flush pull handle and strike plate.

Embodiments of the present lockset include a strike plate that is mounted to a door, and a lockset sub-assembly that is mounted to a door jamb. The lockset sub-assembly includes a sub-assembly body and an actuating arm mounted inside of the body. The actuating arm is connected axially to a rotatable extension of a thumb turn. The thumb turn is mounted outside of the sub-assembly body. During operation, the distal end of the actuating arm moves, that is, rotates from an unlocked position during which the actuating arm rests inside of the lockset sub-assembly body to a locked position during which the distal end of the actuating arm has been rotated into and rests within a slot in the strike plate and extends into a corresponding slot or cavity in the door and that is under the strike plate. Preferably the strike plate is flat, is mounted on the door, and has a relatively large opening adapted for the user to pull or push the door along a rail that is mounted to a wall and at position that is above the door opening. The strike plate preferably has a thickness, i.e., depth into the door of its side walls into the door that is sufficient to enable a user's fingers to push or pull the door along the rail. The strike plate preferably also includes a vertical slot positioned at one end of the strike plate and within which the actuating arm is rotated, i.e., inserted into the slot to lock the door. Rotation of the actuating arm, also referred to as the latch arm, in the opposite direction causes the actuating arm to rotate out of, that is, to be withdrawn from the slot to unlock the door.

The actuating arm within the lockset sub-assembly offers an arc of rotation of approximately 180 degrees. Generally, this is more than is needed for normal operation. Generally the arc only needs approximately 90 degrees of rotation which would allow the arm to rotate from the vertical position within the lockset body to a horizontal position within the strike plate. Complete rotation would allow the arm to rotate through the strike plate slot into a second unlocked position. To prevent this through rotation, a bump is installed within the strike plate slot to stop this rotation. The ability for the lockset body to operate the full rotation is to allow the same lock body to be mounted on the opposite side of the door jam and still operate from the upper vertical position to the horizontal position, and vice versa. Similarly, the strike plate slot allows the lock body arm to enter from the top or bottom of the slot before hitting the bump. This again, allows the strike plate to be mounted on the opposite end of the door for a reverse sliding door. Having these options incorporated in the lockset reduces the number of SKUs required for left hand versus right hand opening doors. However, the device could be made in a left-hand only and a right-hand only version.

The door preferably has a pocket or cavity that corresponds to or complements the opening in the flush pull handle. The flush pull handle includes a surface mounted strike plate, with a pocket that is sized, dimensioned and configured to provide a user's hand(s) with a place to grip. During operation, the pocket is gripped and then pushed or pulled by the user to open and close the door, that is, for the door to reciprocate along the rail during operation. The strike plate is positioned approximately flush with or below the surface of the door to insure that the strike plate does not catch on the doorjamb, on the trim surface of the door jam or on the lockset as the door slides past. The back of the flush pull handle preferably extends into the body of the door to a depth greater than the depth that a conventional pull handle extends into a door body. Also, the width of the strike plate is greater than the width of a typical, conventional, residential door strike plate. This greater width enables both the slot and the flush pull handle to be integrated with or included on the same plate.

Embodiments, examples, features, aspects, and advantages of the present disclosure will become better understood with regard to the following description, appended claims and accompanying drawings.

### BRIEF DESCRIPTION OF THE DRAWINGS

The detailed description of exemplary embodiments herein makes reference to the accompanying drawings and figures, which show the exemplary embodiments by way of illustration and best mode. While these exemplary embodiments are described in sufficient detail to enable those skilled in the art to practice the invention, it should be understood that other embodiments may be realized and that logical changes may be made without departing from the spirit and scope of the invention. Thus, the detailed description herein is presented for purposes of illustration only and not of limitation. Moreover, any reference to singular includes plural embodiments, and any reference to more than one component may include a singular embodiment.

FIG. 1 is a perspective view of an embodiment of a residential barn door type door shown for use as a bathroom door, but without a lockset;

FIG. 2 is a perspective view of an embodiment of a residential barn door type door shown for use as a bedroom door, but without a lockset;

FIG. 3 is a perspective view of an embodiment barn door lockset of the present invention shown with the lockset strike plate mounted on a door and the lockset latch sub-assembly mounted on a corresponding doorjamb;

FIG. 4 is an exploded, perspective view of the latch sub-assembly of the FIG. 3 embodiment showing the spatial and functional relationship of the latch sub-assembly and its mounting bracket, each to the other;

FIG. 5 is a perspective view of the FIG. 3 embodiment latch sub-assembly showing the latch sub-assembly with its thumb turn and latch arm in a locked position.

FIG. 6 is an exploded, perspective view of the latch sub-assembly and mounting bracket of the FIG. 3 embodiment showing internal components and their spatial and functional relationships, each to the other.

FIG. 7 is a front view of the FIG. 3 embodiment latch arm.

FIG. 8 is a back view of the FIG. 3 embodiment latch arm assembly with the rear cover removed.

FIG. 9 is a section view of the FIG. 3 embodiment latch sub-assembly with the flush pull with integrated strike mounted inside the pocket of the sliding door.

FIG. 10 is a section view of the FIG. 3 embodiment latch sub-assembly with the latch arm partially extending through the slot in the strike plate.

Reference symbols or names are used in the figures to indicate certain components, aspects or features shown therein. Reference numerals common to more than one figure indicate like components, aspects or features shown therein.

### DETAILED DESCRIPTION OF INVENTION

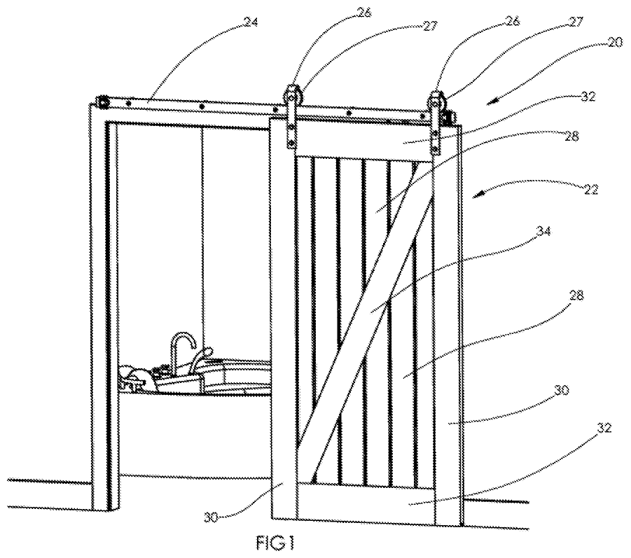

In accordance with embodiments described herein FIG. 1 illustrates a barn door type door assembly 20 of the present invention adapted for use as a door for a residential bathroom, but without a lockset. Assembly 20 includes door 22 mounted on rail 24. Door 22 preferably and operatively hangs on rail 24 from two door extension arms 26, 26, which are provided with wheels 27, 27 to permit door 22 to slide back and forth, or reciprocate along rail 24. Door 22 includes several vertically extending boards or facsimiles of boards (hereinafter referred to as “boards”) 28, 28 extending vertically and positioned in the central part or section of door 22, between vertically extending border boards 30, 30 that extend vertically along the left and right side of door 22, respectively, and between top and bottom boarder boards 32, 32 that extend horizontally along the top and the bottom of door 22, respectively. The FIG. 1 embodiment also includes diagonal board 34 that preferably extends diagonally across door 22, from the lower left corner where the border boards are joined, to the upper right corner where the border boards are also joined.

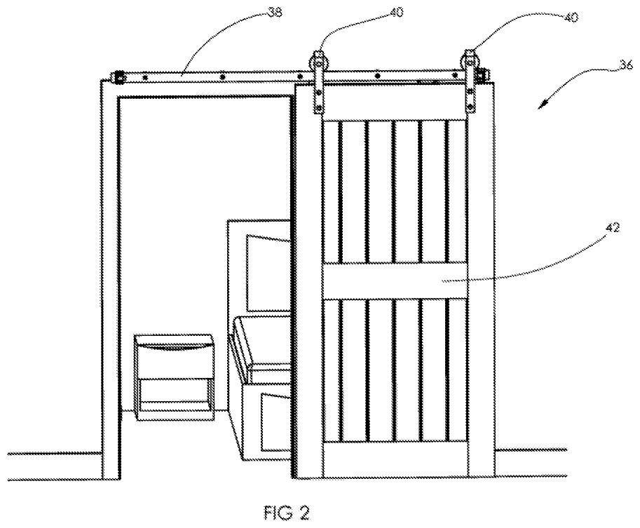

FIG. 2 shows an alternate embodiment barn door type assembly 36 for use as a bedroom door, but without a lockset. Assembly 36 includes a door (not numbered) mounted on rail 38 with the assembly including relatively narrow door extension arms 40, 40, which are provided with wheels (not numbered) to permit the door to slide back and forth, or reciprocate along rail 38, as described above in regard to FIG. 1. The FIG. 2 embodiment door also includes horizontally extending and vertically extending boarder boards (not numbered), as shown in FIG. 1. The center section of the alternate embodiment door shown in FIG. 2 includes one horizontally extending board 42, rather than a diagonally extending board as shown in the FIG. 1 embodiment.

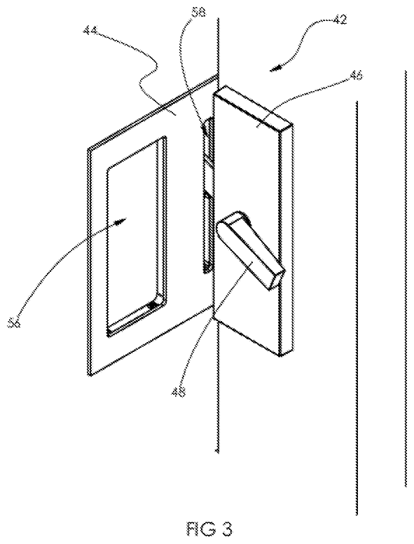

FIG. 3 is a right side, perspective view of preferred embodiment lockset 42 of the present invention showing strike plate 44 mounted to a door (not numbered) and latch sub-assembly 46 mounted to a door jamb (not numbered). Thumb turn 48 is shown rotated into the locked position, thereby rotating the latch arm and extending into the strike plate slot 58, in a position that is fully locked (approximately 85 degrees from vertical) position. Lockset 42 is adapted to be mounted on any of the FIG. 1 embodiment door, the FIG. 2 embodiment door, or other styles or types of doors that reciprocate between an open and a closed or shut position, such as the type of sliding doors used on closets, and the type of sliding doors referred to as “pocket doors”

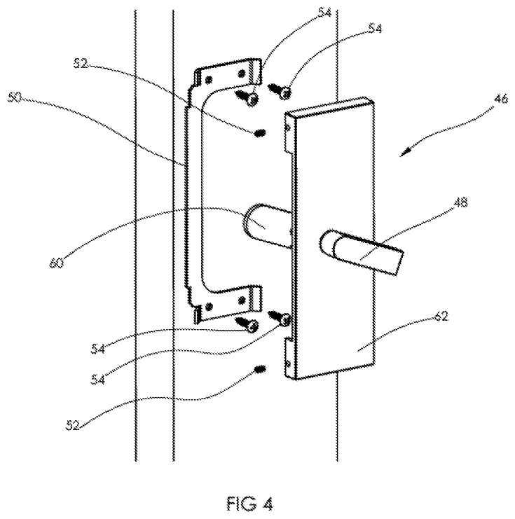

FIG. 4 is an exploded view of the FIG. 3 embodiment lockset, showing latch sub-assembly 46 from a left side, perspective view. Sub-assembly 46 is shown mounted to surface mount bracket 50 with two set screws 52. Bracket 50 is shown mounted to the door jamb (not numbered) with four screws 54.

Referring to FIGS. 3 and 4, strike plate 44 preferably is flat, has an opening 56 and a thickness sufficient for a user's fingers to push or pull the door along rail 24 or 38, as shown in FIGS. 1 and 2. Strike plate 44 preferably has two openings; a relatively large area opening 56 for the user's hand(s) and a vertically oriented slot 58 sized and positioned to receive the distal end of latch or actuating arm 60. The area of opening 56 for the user's hand(s) is relatively large in comparison to the area of slot 58 for receiving the distal end of the actuating arm 60. The opening 56 is large enough to permit a user to pull or push, with his or her fingers, the door along rail 24 or 38, respectively, as shown in FIGS. 1 and 2. The strike plate slot 58 is preferably positioned near the leading edge of the door, and preferably is a vertical slot within which actuating arm 60 is inserted to lock the door.

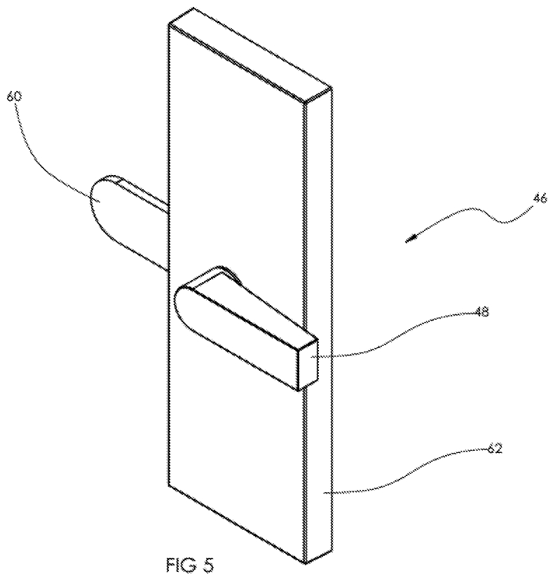

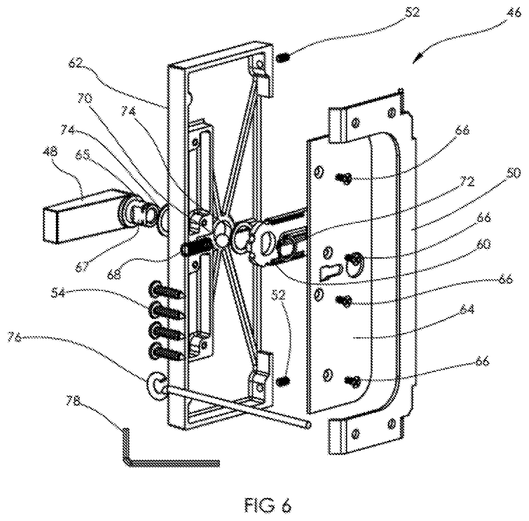

Referring to FIGS. 3 through 6, the locked position is shown in FIG. 5, and rotation of the thumb turn 48 clockwise causes the actuating arm 60 to rotate out of the slot 58 in the strike plate to unlock the door. Starting from the unlocked position, rotation of the thumb turn 48 in the counterclockwise direction causes actuating arm 60 to rotate out from under cover 62 and to be inserted into and through slot 58 in strike plate 44 to lock the door as shown in FIGS. 3 and 4. Lockset sub-assembly 46 is mounted to the door jamb face and thumb turn 48 includes an extension or spindle 65, described and shown in detail with reference to FIG. 6. Spindle 65 extends at a right angle from thumb turn 48. Spindle 65 extends into latch sub-assembly 46 and extends through a slot, or mounting hole in actuating arm 60. The actuating arm 60 mounting hole includes a flat surface (not numbered) that truncates part of the mounting hole and functions to enable actuating arm 60 to mate to, and positively align with flat surface 67 on spindle 65 as shown in FIG. 6. Actuating arm 60 has an arc of rotation preferably extending from the top of strike plate slot 58 to the bottom of slot 58. Other arcs of rotation may be used so long as the actuating arm can be moved from a fully locked position to a fully unlocked position, and vice versa. By way of example, the arc of rotation may range between approximately 45 to 135 degrees (fully locked at approximately 80 degrees) in lock position. Strike plate 44 is mounted on the sliding door, near the leading edge of the door, and preferably is placed over a corresponding cavity or pocket in the door. Strike plate slot 58 is sized, configured and positioned to allow or permit the distal end of actuating arm 60 to rotate into, and out of slot 58 as thumb turn 48 is operated to lock/unlock the door when the door is closed. Slot 58 is preferably vertically oriented, extends along a substantial part of the height of strike plate 44, and is wide enough and deep enough to accommodate a substantial length of actuating arm 60.

FIG. 5 is an enlarged, perspective view of the front or exterior side of latch sub-assembly 46 when in the fully locked position. Surface mount cover 62 is shown it its vertically mounted position, and thumb turn 48 and latch arm 60 are shown extending horizontally, with the distal end of latch arm 60 shown as it would be when fully extending through slot 58 in strike plate 44 and into the pocket in the door.

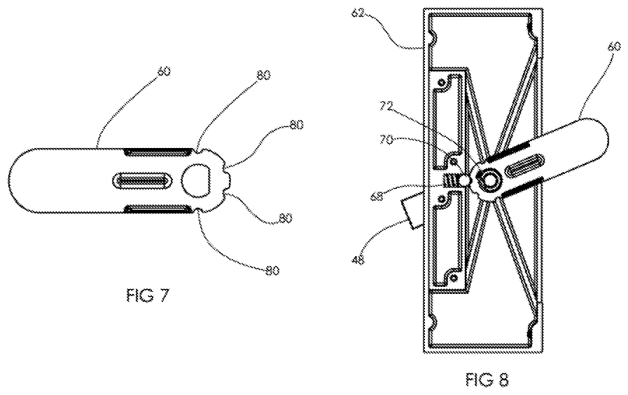

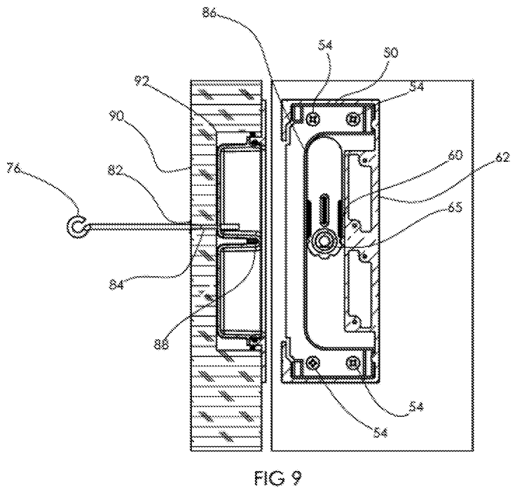

FIG. 6 is an enlarged, exploded perspective view of latch sub-assembly 46, showing cover 62, thumb turn 48, latch arm 60 and internal components. During use, bracket 50 would be mounted to the door jam, preferably with screws 54, as described above and also shown in regard to FIGS. 3 and 4. Screws 54 preferably are #8 pan head, ¾ inch long Phillips screws. Back plate 64 is mounted to the back side of cover 62, preferably with screws 66. Screws 66 are preferably #4-40×25 flat head Phillips machine screws. Spring 68 and steel ball 70 cooperate with indentations 80 (as shown in FIG. 7) in actuating arm 60 to provide a positive locating function. As the actuating arm is rotated, the indentations rotate toward the sprung steel ball. Once the sprung steel ball contacts the indentation (as shown in FIG. 8), the ball 70 will naturally rest in the center of one of the indentations 80 and the actuating arm 60 will rest in this position. A slightly elevated force will be required to move the actuating arm 60 away from this position. Retaining ring 72 and both of plastic washers 74 function to hold thumb turn 48 and actuating arm 60 together and to constrain them under cover 62 during rotation of thumb turn 48. Also shown in FIG. 6 is egress pin 76 and Allen key 78. Egress pin 76 is used from the opposite door side of the thumb turn side of the door as shown in FIG. 9. During use, pin 76 is pushed through a small hole in a bushing 82, that is mounted within hole 84 of the door. During use, pin 76 functions to push the actuating arm 60 into the unlocked position in the event of an emergency or other situation requiring entry through the doorway without forcing the lockset or damaging the lockset, the door and/or the doorway. Allen key 78 is provided for use during installation and functions to tighten set screws 52, thereby securing surface mount bolt cover 62 to surface mount bracket 50, and securing both the cover and the bracket to the door jamb.

With reference to FIGS. 3 through 6, operation of the lockset will be described. When the door is closed or shut, and the lockset is in the fully locked position, the actuating arm 60 extends substantially horizontal as shown in FIG. 5. The lockset can be unlocked by rotating thumb turn 48 downward (clockwise direction in FIG. 5) from a substantial horizontal resting position. Then the actuating arm 60 will be rotated upward (clockwise direction) to a substantial vertical position such that the actuating arm 60 is rotated out of slot 58 in strike plate 44 and is then contained within surface mount bolt cover 62. When the actuating arm 60 is within bolt cover 62, the lockset is in the unlocked position and the sliding door is free to move back and forth. From the unlocked position, lockset sub-assembly 46 can be operated to lock the door, that is, to constrain the movement of the door, by rotating thumb turn 48 to a position away from substantial vertical to cause the actuating arm 60 to rotate and pass though slot 58 in strike plate 44 and to enter the corresponding cavity within the door.

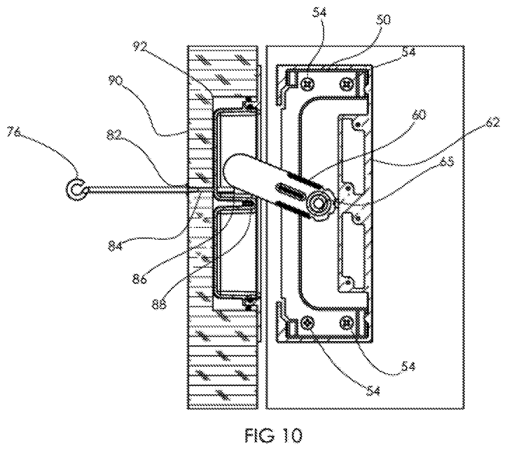

FIG. 10 shows a bump 88, underneath the bottom edge of the actuating arm 60, that prevents the actuating arm 60 from passing through the slot 58 referenced in FIG. 3. This bump acts as a brake that hinders motion of arm 60 and prevents the latch from “passing through” the slot. This bump prevents unintentional unlocking of the door when moving from a vertical “unlocked” state and passing through the slot to the next vertical “unlocked” state.

Although specific embodiments of the disclosure have been described, various modifications, alterations, alternative constructions, and equivalents are also encompassed within the scope of invention as set forth in the claims.

The previous description of the disclosed examples is provided to enable any person of ordinary skill in the art to make or use the disclosed invention. Various modifications to the examples will be readily apparent to those skilled in the art, and the principles defined herein may be applied to other examples without departing from the spirit or scope of the disclosed apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the broader spirit and scope of the disclosed invention.

What is claimed is:

1. A sliding door and surface mount lockset assembly comprising;
a sliding door mounted to a doorway and a lockset, wherein the sliding door slidably mounted on a rail positioned above the doorway;
the lockset that comprises:
a strike plate adapted to be mounted to the sliding door wherein the striking plate includes a slot;
a bracket adapted to be mounted to a door jamb of the doorway; and
a lockset sub-assembly adapted to be mounted to the bracket wherein the lockset sub-assembly includes a bolt cover, a bolt thumb turn rotatably mounted exterior to the bolt cover, having a centerline of rotation and a predetermined arc of rotation;
the lockset sub-assembly further comprises an actuating arm connected to the bolt thumb turn, configured to be rotated by the bolt thumb turn in a direction orthogonal to the centerline of rotation of the bolt thumb turn, the actuating arm is configured to be rotated into the slot of the striking plate;
the lockset sub-assembly further comprises a spring and a steel ball wherein the spring is configured to urge the ball into contacting the actuating arm.

2. The sliding door and surface mount lockset assembly of claim 1, wherein the rotation of the bolt thumb turn causes the actuating arm to rotate into the slot of the strike plate and prevent the sliding door from sliding on the rail.

3. The sliding door and surface mount lockset assembly of claim 1, wherein the slot of the strike plate further includes a bump adapted to prevent the actuating arm from rotating out of the slot of the striking plate.

3. The sliding door and surface mount lockset assembly of claim 1, wherein the arc of rotation of the bolt thumb turn is in the range of approximately 45 to 135 degrees.

4. The sliding door and surface mount lockset assembly of claim 1, wherein the actuating arm further comprises one or more indentations wherein the one or more indentations are adapted to engage the ball such that the actuating arm rests in the location dictated by the location of the one or more indentations.

5. The sliding door and surface mount lockset assembly of claim 1 further comprises an egress pin configured to push the actuation arm out of the slot of the striking plate through the side of the sliding door that is opposite to the side where the strike plate is mounted.

6. The sliding door and surface mount lockset assembly of claim 1, wherein the strike plate further comprises an opening configured to permit a user to use the opening to pull or push the sliding door along the rail.
